(19) United States
(12) Patent Application Publication
(10) Pub. No.: US 2022/0200757 A1
(43) Pub. Date: Jun. 23, 2022

(54) METHOD AND APPARATUS OF FREQUENCY-SELECTIVE PRECODING FOR PHYSICAL UPLINK SHARED CHANNEL TRANSMISSION

(71) Applicant: GUANGDONG OPPO MOBILE TELECOMMUNICATIONS CORP., LTD., Dongguan (CN)

(72) Inventor: Li GUO, Dongguan (CN)

(21) Appl. No.: 17/558,880

(22) Filed: Dec. 22, 2021

Related U.S. Application Data
(63) Continuation of application No. PCT/CN2020/101623, filed on Jul. 13, 2020.
(60) Provisional application No. 62/877,112, filed on Jul. 22, 2019.

(51) Int. Cl. H04L 5/00

(52) U.S. Cl. CPC H04L 5/0051; H04L 5/0016

(57) ABSTRACT

Methods and apparatuses of frequency-selective precoding for physical uplink shared channel (PUSCH) transmission are provided. A method of frequency-selective precoding for physical uplink shared channel (PUSCH) transmission of a user equipment (UE) includes receiving, from a base station (BS), configuration information for a set of sounding reference signal (SRS) resources and a downlink reference signal (RS) for measuring channel state information and identifying a precoder for an SRS resource in the set of SRS resources according to a precoding granularity value that can be configured to the SRS resource or determined by the UE for the SRS resource.

### CROSS REFERENCE TO RELATED APPLICATIONS

The disclosure is a continuation of an International Application No. PCT/CN2020/101623, filed on Jul. 13, 2020, titled “METHOD AND APPARATUS OF FREQUENCY-SELECTIVE PRECODING FOR PHYSICAL UPLINK SHARED CHANNEL TRANSMISSION”, which claims priority of U.S. provisional patent application No. 62/877,112 filed on Jul. 22, 2019, which is incorporated by reference in the present application in its entirety.

### BACKGROUND OF DISCLOSURE

### 1. Field of Disclosure

The present disclosure relates to the field of communication systems, and more particularly, to methods and apparatuses of frequency-selective precoding for physical uplink shared channel (PUSCH) transmission.

### 2. Description of Related Art

In current designs, a current method degrades an uplink performance of a physical uplink shared channel (PUSCH) transmission in rich multipath mobile communication environments. Multipath causes a frequency-selective channel in a frequency domain. Different resource blocks in the frequency domain in the PUSCH transmission generally experience different fading channels and thus ‘optimal’ precoders for resource blocks are generally different from each other. The current method can only support a user equipment (UE) to apply same precoder on all the resource blocks in the frequency domain of one PUSCH transmission. A beamforming gain on an uplink PUSCH transmission is limited and thus an uplink transmission performance is degraded.

Therefore, there is a need for methods and apparatuses of frequency-selective precoding for physical uplink shared channel (PUSCH) transmission.

### SUMMARY

An object of the present disclosure is to propose methods and apparatuses of frequency-selective precoding for physical uplink shared channel (PUSCH) transmission capable of providing at least one of advantages including selecting a best precoding granularity and also a best precoder for each subband of one PUSCH transmission, increasing a beamforming gain on the PUSCH transmission, and increasing a coverage and throughput of an uplink transmission in a new radio (NR) system.

In a first aspect of the present disclosure, a method of frequency-selective precoding for physical uplink shared channel (PUSCH) transmission of a user equipment (UE) includes receiving, from a base station (BS), configuration information for a set of sounding reference signal (SRS) resources and a downlink reference signal (RS) for measuring channel state information and identifying a precoder for an SRS resource in the set of SRS resources according to a precoding granularity value.

In a second aspect of the present disclosure, a user equipment (UE) of frequency-selective precoding for physical uplink shared channel (PUSCH) transmission includes a memory, a transceiver, and a processor coupled to the memory and the transceiver. The transceiver is configured to receive, from a base station (BS), configuration information for a set of sounding reference signal (SRS) resources and a downlink reference signal (RS) for measuring channel state information and the processor is configured to identify a precoder for an SRS resource in the set of SRS resources according to a precoding granularity value.

In a third aspect of the present disclosure, a method of frequency-selective precoding for physical uplink shared channel (PUSCH) transmission of a base station (BS) includes transmitting, to a user equipment (UE), configuration information for a set of sounding reference signal (SRS) resources, transmitting, to the UE, configuration information of a precoding granularity value for the set of SRS resources, and transmitting, to the UE, a downlink reference signal (RS) for measuring channel state information.

In a fourth aspect of the present disclosure, a base station (BS) of frequency-selective precoding for physical uplink shared channel (PUSCH) transmission includes a memory, a transceiver, and a processor coupled to the memory and the transceiver. The transceiver is configured to transmit, to a user equipment (UE), configuration information for a set of sounding reference signal (SRS) resources, the transceiver is configured to transmit, to the UE, configuration information of a precoding granularity value for the set of SRS resources, and the transceiver is configured to transmit, to the UE, a downlink reference signal (RS) for measuring channel state information.

In a fifth aspect of the present disclosure, a non-transitory machine-readable storage medium has stored thereon instructions that, when executed by a computer, cause the computer to perform the above method.

In a sixth aspect of the present disclosure, a terminal device includes a processor and a memory configured to store a computer program. The processor is configured to execute the computer program stored in the memory to perform the above method.

In a seventh aspect of the present disclosure, a network node includes a processor and a memory configured to store a computer program. The processor is configured to execute the computer program stored in the memory to perform the above method.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a user equipment (UE) and a base station (BS) of frequency-selective precoding for physical uplink shared channel (PUSCH) transmission according to an embodiment of the present disclosure.

FIG. 2 is a flowchart illustrating a method of frequency-selective precoding for physical uplink shared channel (PUSCH) transmission of a user equipment according to an embodiment of the present disclosure.

FIG. 3 is a flowchart illustrating a method of frequency-selective precoding for physical uplink shared channel (PUSCH) transmission of a base station according to an embodiment of the present disclosure.

FIG. 4 illustrates an example of PUSCH transmission with frequency-selective precoding according to an embodiment of the present disclosure.

FIG. 5 illustrates an example of PUSCH transmission with frequency-selective precoding according to an embodiment of the present disclosure.

FIG. 6 illustrates one procedure of reporting precoding granularity according to an embodiment of the present disclosure.

FIG. 7 is a flowchart illustrating a method of frequency-selective precoding for physical uplink shared channel (PUSCH) transmission according to an embodiment of the present disclosure.

FIG. 8 is a flowchart illustrating a method of frequency-selective precoding for physical uplink shared channel (PUSCH) transmission according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Fifth-generation (5G) wireless systems are generally a multi-beam based system in a frequency range 2 (FR2) ranging from 24.25 GHz to 52.6 GHz, where multiplex transmit (Tx) and receive (Rx) analog beams are employed by a base station (BS) and/or a user equipment (UE) to combat a large path loss in a high frequency band.

In a high frequency band system, for example, mmWave systems, the BS and the UE are deployed with large number of antennas, so that a large gain beamforming can be used to defeat the large path loss and signal blockage. Due to the hardware limitation and cost, the BS and the UE might only be equipped with a limited number of transmission and reception units (TXRUs).

Therefore, hybrid beamforming mechanisms can be utilized in both BS and UE. To get the best link quality between the BS and the UE, the BS and the UE need to align analog beam directions for a particular downlink or uplink transmission.

For a downlink transmission, the BS and the UE need to find the best pair of a BS Tx beam and a UE Rx beam while for an uplink transmission, the BS and the UE need to find the best pair of the UE Tx beam and the BS Rx beam.

In current NR release-15 design, a precoder applied to a physical uplink shared channel (PUSCH) transmission can only be a wideband precoder, i.e., the same precoder is applied to all resource blocks in a frequency domain resource allocation of that PUSCH. Two transmission schemes are supported for PUSCH transmission: codebook-based transmission and non-codebook based transmission. A PUSCH transmission can be granted by a downlink control information (DCI) format 0_1.

For a codebook-based transmission, the DCI format 0_1 indicates precoding information and number of layers. The precoding information indicated in the DCI format 0_1 provides one or more precoder vectors from a precoder set specified in the specification. An example of precoders for four antenna ports and two-layer PUSCH transmission specified in new radio (NR) standard specification is illustrated in table 1.

A user equipment (UE) determines its PUSCH transmission precoder based on a sounding reference signal (SRS) resource indicator (SRI), a transmit precoding matrix indicator (TPMI), and a transmission rank, which are given by DCI fields in the DCI format 1_0. The precoders determined by the UE are wideband precoders and the UE can apply the determined precoders over each layer on all the resource blocks in the frequency domain resource of that PUSCH transmission.

For non-codebook-based transmission, the UE determines an PUSCH precoder and a transmission rank based on the SRI indicated in the DCI format 1_0. The UE would apply the same precoder on PUSCH transmission as the precoder applied on the SRS resources that are indicated by the SRI field in the DCI. The UE maps each indicated SRS resource to one demodulation reference signal (DM-RS) port of the PUSCH transmission.

The procedure for non-codebook based PUSCH transmission is: the UE first measures downlink reference signal to estimate candidate uplink precoders. The UE applies those candidate precoders on SRS resources configured for non-codebook-based transmission. The UE transmits those SRS resources and a generation Node-B (gNB) measures uplink channel by measuring the transmissions of those SRS resources. The gNB determines a resource allocation, ‘best’ SRS resources, and a modulation and coding scheme (MCS) level for PUSCH transmission. The gNB indicates that information to the UE through a DCI format.

Based on the control information in DCI, the UE determines the precoder(s) and number of layers for PUSCH transmission. As specified in current design, the precoder applied to SRS resource is wideband and thus the precoder applied to PUSCH transmission is also wideband.

TABLE 1

| TPMI | | | | |
|---|---|---|---|---|
| index | W (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

FIG. 1 illustrates that, in some embodiments, a user equipment (UE) 10 and a base station (BS) 20 of frequency-selective precoding for physical uplink shared channel (PUSCH) transmission according to an embodiment of the present disclosure are provided. The UE 10 may include a processor 11, a memory 12, and a transceiver 13. The base station 20, such as a generation Node-B (gNB), may include a processor 21, a memory 22 and a transceiver 23. The processor 11 or 21 may be configured to implement proposed functions, procedures and/or methods described in this description. Layers of radio interface protocol may be implemented in the processor 11 or 21.

The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include an application-specific integrated circuit (ASIC), other chipsets, logic circuit and/or data processing devices. The memory 12 or 22 may include a read-only memory (ROM), a random access memory (RAM), a flash memory, a memory card, a storage medium and/or other storage devices. The transceiver 13 or 23 may include baseband circuitry to process radio frequency signals.

When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21, in which those can be communicatively coupled to the processor 11 or 21 via various means are known in the art.

In some embodiments, the transceiver 13 is configured to receive, from the base station (BS) 20, configuration information for a set of sounding reference signal (SRS) resources and a downlink reference signal (RS) for measuring channel state information and the processor 11 is configured to identify a precoder for an SRS resource in the set of SRS resources according to a precoding granularity value that can be configured to the SRS resource or determined by the UE 10 for the SRS resource.

In some embodiments, the transceiver 13 is configured to receive, from the BS 20, a first precoding granularity value for the set of SRS resources and the processor 11 is configured to calculate the precoder for the SRS resource in the set of SRS resources according to the first precoding granularity value.

In some embodiments, the processor 11 is configured to determine the precoding granularity value for the SRS resource in the set of SRS resources according to the channel state information.

In some embodiments, the transceiver 13 is configured to report the determined precoding granularity value to the BS 20.

In some embodiments, the transceiver 13 is configured to receive, from the BS 20, an indication signaling that schedules a PUSCH transmission and the processor 11 is configured to carry an indicator that indicates the set of SRS resources and the SRS resource in the set of SRS resources.

In some embodiments, the transceiver 13 is configured to transmit the PUSCH transmission with the precoder and the precoding granularity value used by the indicated SRS resource in the indicated set of SRS resources.

In some embodiments, the transceiver 13 is configured to transmit the PUSCH transmission with a precoding granularity value which is equal to or greater than the precoding granularity value used by the SRS resource in the set of SRS resources.

In some embodiments, the transceiver 13 is configured to receive from, the BS 20, configuration information of N SRS resources and each precoding granularity value configured to each SRS resource, and the precoding granularity value configured to a first SRS resource can be different from the that configured to a second SRS resource.

In some embodiments, the transceiver 23 is configured to transmit, to the user equipment (UE) 10, configuration information for a set of sounding reference signal (SRS) resources, the transceiver 23 is configured to transmit, to the UE 10, configuration information of a precoding granularity value for the set of SRS resources, and the transceiver 23 is configured to transmit, to the UE 10, a downlink reference signal (RS) for measuring channel state information.

In some embodiments, the transceiver 23 is configured to receive, from the UE 10, a precoding granularity report for an SRS resource in the set of SRS resources.

In some embodiments, the transceiver 23 is configured to receive an SRS transmission in the set of SRS resources and the processor 21 is configured to select an SRS resource in the set of SRS resources.

In some embodiments, the transceiver 23 is configured to transmit, to the UE 10, a signaling command that schedules a PUSCH transmission and coveys an indicator that indicates the set of SRS resources and an SRS resource in the set of SRS resources.

In some embodiments, the transceiver 23 is configured to receive, from the UE 10, the PUSCH transmission by assuming a PUSCH uses the same precoding granularity value as the SRS resource in the set of SRS resources.

In some embodiments, the transceiver 23 is configured to transmit, to the UE 10, configuration information of N SRS resources and each precoding granularity value configured to each SRS resource, and the precoding granularity value configured to a first SRS resource can be different from the that configured to a second SRS resource.

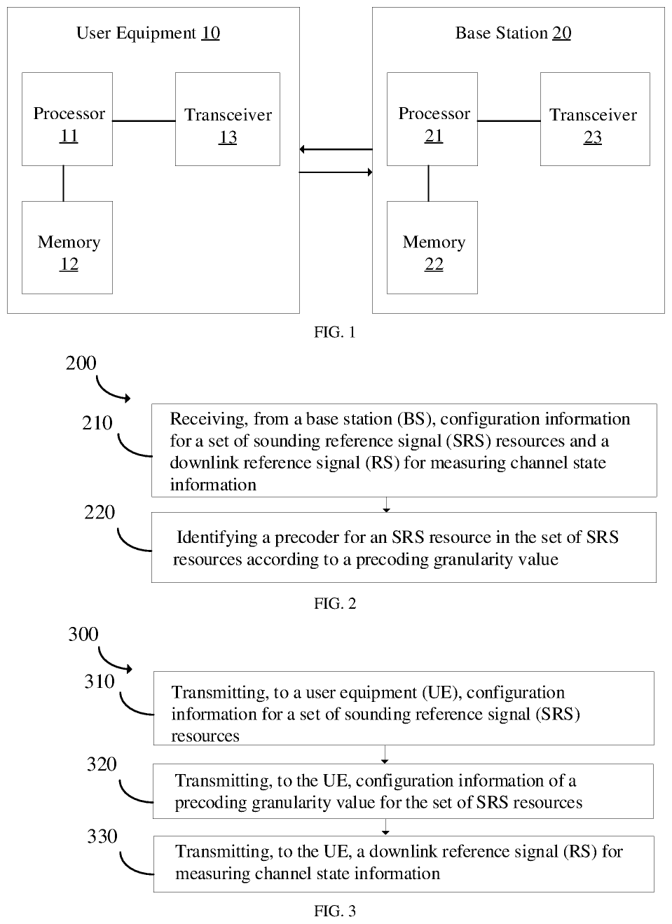

FIG. 2 illustrates a method 200 of frequency-selective precoding for physical uplink shared channel (PUSCH) transmission of a user equipment according to an embodiment of the present disclosure. The method 200 includes: a block 210, receiving, from a base station (BS), configuration information for a set of sounding reference signal (SRS) resources and a downlink reference signal (RS) for measuring channel state information, and a block 220, identifying a precoder for an SRS resource in the set of SRS resources according to a precoding granularity value that can be configured to the SRS resource or determined by the UE for the SRS resource.

In some embodiments, the method further includes receiving, from the BS, a first precoding granularity value for the set of SRS resources and calculating the precoder for the SRS resource in the set of SRS resources according to the first precoding granularity value.

In some embodiments, the method further includes determining the precoding granularity value for the SRS resource in the set of SRS resources according to the channel state information.

In some embodiments, the method further includes reporting the determined precoding granularity value to the BS.

In some embodiments, the method further includes receiving, from the BS, an indication signaling that schedules a PUSCH transmission and carries an indicator that indicates the set of SRS resources and the SRS resource in the set of SRS resources.

In some embodiments, the method further includes transmitting the PUSCH transmission with the precoder and the precoding granularity value used by the indicated SRS resource in the indicated set of SRS resources.

In some embodiments, the method further includes transmitting the PUSCH transmission with a precoding granularity value which is equal to or greater than the precoding granularity value used by the SRS resource in the set of SRS resources.

In some embodiments, the method further includes receiving from, the BS, configuration information of N SRS resources and each precoding granularity value configured to each SRS resource, wherein the precoding granularity value configured to a first SRS resource can be different from the that configured to a second SRS resource.

FIG. 3 illustrates a method 300 of frequency-selective precoding for physical uplink shared channel (PUSCH) transmission of a base station (BS) according to an embodiment of the present disclosure. The method 300 includes: a block 310, transmitting, to a user equipment (UE), configuration information for a set of sounding reference signal (SRS) resources, a block 320, transmitting, to the UE, configuration information of a precoding granularity value for the set of SRS resources, and a block 330, transmitting, to the UE, a downlink reference signal (RS) for measuring channel state information.

In some embodiments, the method further includes receiving, from the UE, a precoding granularity report for an SRS resource in the set of SRS resources.

In some embodiments, the method further includes receiving an SRS transmission in the set of SRS resources and selecting an SRS resource in the set of SRS resources.

In some embodiments, the method further includes transmitting, to the UE, a signaling command that schedules a PUSCH transmission and coveys an indicator that indicates the set of SRS resources and an SRS resource in the set of SRS resources.

In some embodiments, the method further includes receiving, from the UE, the PUSCH transmission by assuming a PUSCH uses the same precoding granularity value as the SRS resource in the set of SRS resources.

In some embodiments, the method further includes transmitting, to the UE, configuration information of N SRS resources and each precoding granularity value configured to each SRS resource, wherein the precoding granularity value configured to a first SRS resource can be different from the that configured to a second SRS resource.

In some embodiments of the present disclosure, methods for frequency selective precoding for PUSCH transmission are proposed. In one embodiment, a UE can be configured with one or more SRS resources for PUSCH transmission. For each SRS resource, the UE can be configured with a precoding granularity P_{SRS}. With that configuration, the UE can assume that the precoding granularity for transmission on the corresponding SRS resources is P_{SRS} consecutive resource blocks in the frequency domain. Examples of P_{SRS} value can be 2, 4, or wideband. Please note, ifP_{SRS}=wideband, the UE can assume that, the precoding granularity for transmission on the corresponding SRS resources is all the resource blocks in the frequency domain in the given bandwidth part (BWP). For transmission on each SRS resource, the UE can determine precoder(s) for each P_{SRS} consecutive resource blocks according to downlink channel measurement and the configuration of P_{SRS}. A gNB can command the UE to transmit those SRS resources. As indicated, the UE can apply the determined precoder on transmission on each SRS resource according to the configured precoding granularity. The gNB measures the transmission on those SRS resources and the gNB can determine which SRS resource(s) is best for PUSCH transmission. The gNB then schedules one PUSCH transmission and indicates one or more SRS resources of those SRS resources to the UE. The UE can determine the precoding granularity and precoders for the scheduled PUSCH according to the indicated SRS resource indicator and then transmit the PUSCH with determined precoder and precoding granularity.

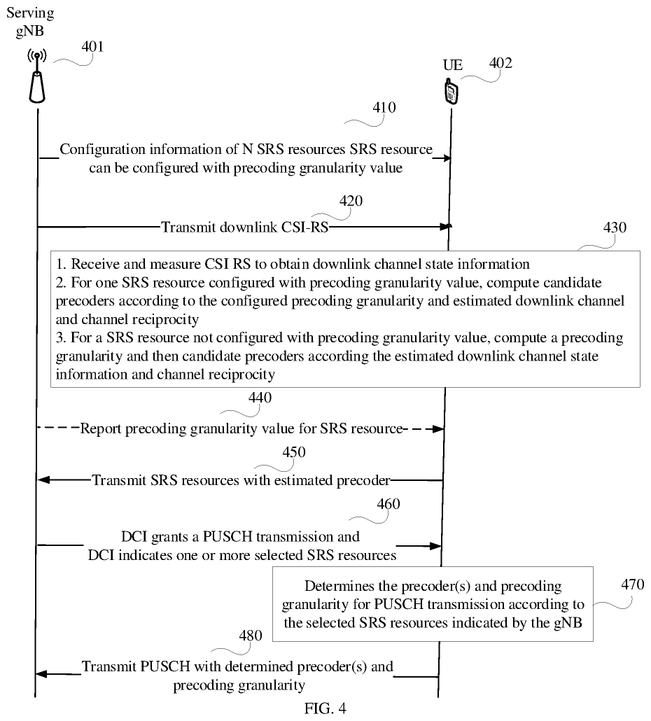

FIG. 4 illustrates an example of PUSCH transmission with frequency-selective precoding according to an embodiment of the present disclosure. FIG. 4 illustrates that, in some embodiments, a serving gNB 401 configures a UE 402 for PUSCH transmission. The serving gNB 401 first configures SRS resources for PUSCH to the UE 402. At an operation 410, the serving gNB 401 sends configuration information of N SRS resources to the UE 402 and for one SRS resource, the serving gNB 401 can configure precoding granularity. Example of precoding granularity parameter can be {2, 4, wideband}. Then the serving gNB 401 sends downlink channel state information reference signal (CSI-RS) 420 to the UE 402. The UE 402 can estimate the channel state information of the downlink link between the serving gNB 401 and the UE 402 through measuring the CSI-RS transmission 420. By exploring the channel reciprocity, the UE 402 can estimate the uplink channel state information based on the downlink channel state information estimated from downlink CSI-RS transmission 420 and then the UE 402 can compute candidate precoder and candidate precoding granularity (if not configured) for uplink transmission.

For an SRS resource configured with a precoding granularity value, the UE 402 computes candidate precoders based on the configured precoding granularity, downlink channel state information, and channel reciprocity. For an SRS resource not configured with a precoding granularity, the UE 402 can compute a precoding granularity and then the candidate precoder(s) according to the downlink channel state information estimated by measuring downlink CSI-RS transmission and the channel reciprocity. The UE 402 can report the determined precoding granularity for an SRS resource to the serving gNB 402 at an operation 440. Then at an operation 450, the UE 402 transmits SRS resources that are configured for PUSCH transmission. For the transmission on each SRS resource, the UE 402 can apply the precoders that the UE 402 computes by assuming precoding granularity configured to that SRS resource. And the UE 402 can apply precoder for transmission on each SRS resource according to the precoding granularity configured to the SRS resource. The serving gNB 402 measures the transmission on each SRS resource.

The serving gNB 402 can measure the channel quality of each SRS resource and then determine the supportable MCS and number of layers. The serving gNB 402 can then determine which SRS resource is the best choice for PUSCH transmission. At an operation 460, the serving gNB 402 sends one DCI format to grant a PUSCH transmission. For the granted PUSCH transmission, the serving gNB 402 indicates one or more SRS resources (for example, in the DCI format) to the UE 402. The UE 402 determines the precoders and precoding granularity for the granted PUSCH transmission according to the indicator of SRS resources signaled by the serving gNB 402. In one example, the UE 402 can apply the same precoding granularity on the granted PUSCH transmission as the precoding granularity configured to the SRS resource that is indicated by the serving gNB 402 at an operation 470. Then at an operation 480, the UE 402 can transmit PUSCH with determined precoding granularity and precoder(s) to the serving gNB 402.

In summary, FIG. 4 illustrates that, in some embodiments, the serving gNB 401 configuring the UE 402 for PUSCH transmission includes: at the operation 410, configuration information of N SRS resources SRS resource can be configured with precoding granularity value by the serving gNB 401 to the UE 402, at the operation 420, the serving gNB 401 transmits downlink CSI to the UE 402, at the operation 430, the UE 402 can receive and measure CSI RS to obtain downlink channel state information, for one SRS resource configured with precoding granularity value, the UE 402 can compute candidate precoders according to the configured precoding granularity and estimated downlink channel and channel reciprocity, for an SRS resource not configured with precoding granularity value, the UE 402 can compute a precoding granularity and then candidate precoders according to the estimated downlink channel state information and channel reciprocity, at the operation 440 (optional example) , the UE 402 can report precoding granularity value for SRS resource to the serving gNB 401, at the operation 450, the UE 402 can transmit SRS resources with estimated precoder to the serving gNB 401, at the operation 460, DCI grants a PUSCH transmission and DCI indicates one or more selected SRS resources from the serving gNB 401 to the UE 402, at the operation 470, the UE 402 determines the precoder(s) and precoding granularity for PUSCH transmission according to the selected SRS resources indicated by the gNB 401, and at the operation 480, the UE 402 can transmit PUSCH with determined precoder(s) and precoding granularity.

In one method, a UE can be configured with N=3 SRS resource sets. For each SRS resource set, the UE can be configured with K≥1 SRS resources. For each SRS resource set, the UE is configured with a precoder granularity value for all the SRS resource contained in that set. For a first SRS set, the configured precoder granularity value can be ‘wideband’, in which the precoding granularity on each SRS resource is wideband. For a second SRS resource set, the configured precoder granularity value can be 2, in which the precoding granularity on each SRS resource is 2 consecutive resource blocks in the frequency domain. For a third SRS resource set, the configured precoder granularity value can be 4, in which the precoding granularity on each SRS resource is 4 consecutive resource blocks in the frequency domain. The UE can also be configured with one downlink CSI-RS resource that is associated with the first SRS resource set, the second SRS resource set, and the third SRS resource set.

A gNB can first transmit the CSI-RS resource for the UE the measure the downlink channel. According to the channel measurement, the UE can compute the precoders for SRS resource in the first SRS resource set, the second SRS resource set, and the third SRS resource set, respectively. For SRS resources in the first SRS resource set, the UE can compute the precoders by assuming precoding granularity=wideband. For SRS resources in the second SRS resource set, the UE can compute the precoders by assuming precoding granularity=2 consecutive resource blocks in the frequency domain. For SRS resources in the third SRS resource set, the UE can compute the precoders by assuming precoding granularity=4 consecutive resource blocks in the frequency domain.

The UE transmits SRS resource in the first SRS resource set, the second SRS resource set, and the third SRS resource set with determined precoders and configured precoding granularity. The gNB can measure the transmission on those SRS resources to determine which precoding granularity and which SRS resources are best choice for PUSCH transmission. Then the gNB can indicate one set identity (ID) to indicate one SRS resource set among the first SRS resource set, the second SRS resource set, and the third SRS resource set, and one or more SRS resource from the indicated SRS resource set to the UE for PUSCH transmission. After receiving the indication information from the gNB, the UE can apply the same precoding granularity and precoders on PUSCH transmission as the indicated SRS resource set and SRS resources in the indicated SRS resource set.

The gNB does not necessarily trigger all three sets of SRS resource. The gNB can trigger the UE to transmit only one of those SRS resource sets. In one example, the gNB triggers the UE to transmit SRS resources in the first SRS resource set. When receiving the trigger message, the UE transmits SRS resources in the first SRS resource set and the UE can apply the determined precoders and precoding granularity configured to the first SRS resource set on the transmission in SRS resource in the first SRS resource set. In one example, the gNB triggers the UE to transmits SRS resources in the second SRS resource set. When receiving the trigger message, the UE can transmit SRS resources in the second SRS resource set and the UE can apply the determined precoders and precoding granularity configured to the second SRS resource set on the transmission in SRS resource in the second SRS resource set. In one example, the gNB triggers the UE to transmit SRS resources in the third SRS resource set. When receiving the trigger message, the UE transmits SRS resources in the third SRS resource set and the UE can apply the determined precoders and precoding granularity configured to the third SRS resource set on the transmission in SRS resource in the third SRS resource set.

In one example, the gNB triggers the UE to transmit SRS resources in the first SRS resource set and in the second SRS resource set. When receiving the trigger message, the UE transmits SRS resources in the first SRS resource set and the UE can apply the determined precoders and precoding granularity configured to the first SRS resource set on the transmission in SRS resource in the first SRS resource set and the UE transmits SRS resources in the second SRS resource set and the UE can apply the determined precoders and precoding granularity configured to the second SRS resource set on the transmission in SRS resource in the second SRS resource set.

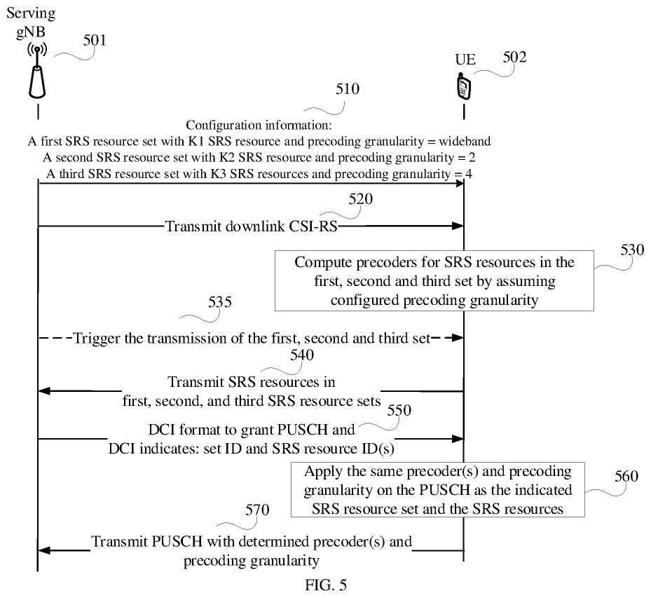

FIG. 5 illustrates an example of PUSCH transmission with frequency-selective precoding according to an embodiment of the present disclosure. FIG. 5 illustrates that, in some embodiments, a serving gNB 501 sends configuration information of SRS resources to a UE 502. The configuration information can include a first SRS resource set with K1 SRS resources and precoding granularity=wideband, a second SRS resource set with K2 SRS resources and precoding granularity=2, and a third SRS resource set with K3 SRS resources and precoding granularity=4.

To assist the UE 502 to estimate downlink channel state information and then estimate uplink transmission parameter, the serving gNB 501 can transmit downlink CSI-RS. The UE 502 receives the downlink CSI-RS and measures downlink channel state information. At an operation 530, the UE 502 can compute precoders for SRS resources in the first SRS resource set, the second SRS resource set, and the third SRS resource set according to the downlink channel state information, channel reciprocity, and the precoding granularity configured to each SRS resource set.

For an SRS resource in the first SRS resource set, the UE 502 can compute precoder according to precoding granularity=wideband, which is configured to the first SRS resource set. For an SRS resource in the second SRS resource set, the UE 502 can compute precoder for each sub-band=2 consecutive resource blocks in a frequency domain according to precoding granularity=2, which is configured to the second SRS resource set. For an SRS resource in the third SRS resource set, the UE 502 can compute precoder for each sub-band=4 consecutive resource blocks the in frequency domain according to precoding granularity=4, which is configured to the third SRS resource set.

The serving gNB 501 can trigger or indicate the UE 502 to transmit SRS resources in one or more or all of those three SRS resource set: the first SRS resource set, the second SRS resource set, and the third resource set. In the example as illustrated in FIG. 5, the serving gNB 501 triggers the UE 501 to transmit SRS resources in the first SRS resource set, the second SRS resource set, and the third SRS resource set. Please note that only is for exemplary illustration. The serving gNB 501 can trigger or indicate the UE 502 to transmit SRS resources in each of those sets separately and independently.

As trigged or indicated by the serving gNB 501, the UE 502 transmit the SRS resources in the corresponding SRS resource set and the UE 502 can apply the determined precoders with configured precoding granularity. In one example, the serving gNB 501 can send one DCI format to grant a PUSCH transmission in an operation 550. In the DCI, the serving gNB 501 can signal indicator for an SRS resource set ID and SRS resource ID(s) for PUSCH transmission. After receiving the DCI, the UE 502 determines SRS resource set and SRS resource ID(s) used for PUSCH transmission. The UE 502 transmits the PUSCH with the precoders and precoding granularity of the SRS resources that are indicated in the DCI.

In summary, FIG. 5 illustrates that, in some embodiments, the serving gNB 501 configuring the UE 502 for PUSCH transmission includes: at the operation 510, configuration information can be configured by the serving gNB 501 to the UE 502, where a first SRS resource set with K1 SRS resource and precoding granularity=wideband, a second SRS resource set with K2 SRS resource and precoding granularity=2, and a third SRS resource set with K3 SRS resources and precoding granularity=4, at the operation 520, the serving gNB 501 transmits downlink CSI-RS to the UE 502, at the operation 530, the UE 502 can compute precoders for SRS resources in the first SRS resource set, the second SRS resource set, and the third SRS resource set by assuming configured precoding granularity, at the operation 535 (optional example), the serving gNB 501 can trigger the transmission of the first SRS resource set, the second SRS resource set, and the third SRS resource set, at the operation 540, the UE 402 can transmit SRS resources in the first SRS resource set, the second SRS resource set, and the third SRS resource set to the serving gNB 401, at the operation 550, DCI format to grant PUSCH and DCI indicates: set ID and SRS resource ID(s) by the serving gNB 501 to the UE 502, at the operation 560, the UE 502 can apply the same precoder(s) and precoding granularity on the PUSCH as the indicated SRS resource set and the SRS resources, and at the operation 570, the UE 502 can transmit PUSCH with determined precoder(s) and precoding granularity.

In one method, a UE can be configured with one or more SRS resource sets and for each SRS resource set, the UE can be configured with K≥1 SRS resources. For each SRS resource, the UE can be configured with a precoding granularity value. For example, the value of precoding granularity can be P={2, 4, wideband}, which means the precoding granularity on SRS resource is P consecutive resource blocks in frequency domain. There are a few alternatives to configure the value of precoding granularity. In an alternate embodiment (Alt 1), the precoding granularity is configured per SRS resource set and then the same precoding granularity is applied to all the SRS resource in one set. In another alternate embodiment (Alt 2), the precoding granularity is configured per SRS resource. If a precoding granularity is configured to one SRS resource, the UE can apply frequency-selective precoder for the transmission on that SRS resource. For SRS resource configured to be semi-persistent, a gNB can send an activation command to the UE to activate the transmission of one SRS resource. The activation command can also contain precoding granularity value for the activated SRS resource. For transmission on an SRS resource in the activated SRS resource set, the UE can apply the precoding granularity that is indicated in the activation command.

For an aperiodic SRS resource, the gNB can use a MAC CE command to update the precoding granularity for the transmission on that SRS resource. When a UE receives a MAC CE command to update the precoding granularity for one SRS resource at slot n, the UE assumption on precoding granularity on SRS transmission corresponding to that SRS resource can be applied starting from slot n+3Nₛₗₒₜ^{subframe,μ}+1.

In one method, a UE can be configured with a first SRS resource set and in the first SRS resource set, the UE can be configured with K≥1 SRS resources. Each SRS resource in the first SRS resource set can be configured with a precoding granularity value. Examples of precoding granularity value can be {2, 4, wideband}. The gNB can configure different or same precoding granularity values to two different SRS resources in the first SRS resource set. In one example, the UE is configured with the first SRS resource set with K=4 SRS resources. SRS #1 configured with precoding granularity=wideband, SRS #2 configured with precoding granularity=2, SRS #3 configured with precoding granularity=4 and SRS #4 configured with precoding granularity=4. Precoding granularity=2 or 4 means 2 or 4 consecutive resource blocks in the frequency domain. Precoding granularity=wideband means the whole allocation bandwidth of an SRS resource. For each SRS resource in the first SRS resource set, the UE can determine precoder(s) according channel estimation and the precoding granularity value configured to that SRS resource. The gNB can indicate one or more SRS resource IDs in the first SRS resource set for a PUSCH transmission to the UE.

In one embodiment, a UE can be requested to report a precoding granularity for PUSCH transmission. The UE can measure some downlink CSI-RS transmission to estimate the downlink channel. According to the channel reciprocity, the UE can estimate uplink channel state based on the estimated downlink channel. Then the UE can compute a precoding granularity for uplink transmission. The UE can report the computed precoding granularity to the gNB.

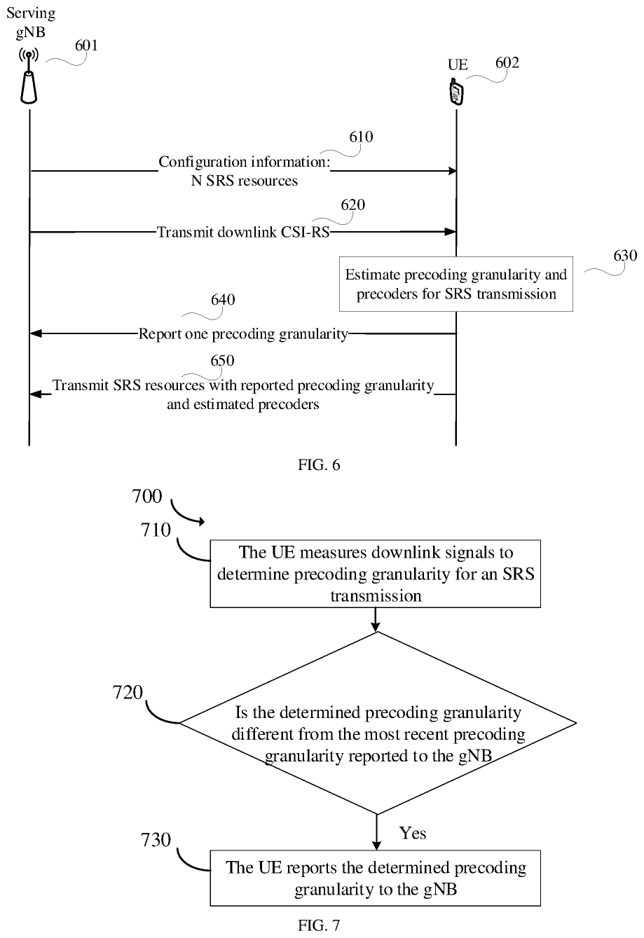

FIG. 6 illustrates one procedure of reporting precoding granularity according to an embodiment of the present disclosure. FIG. 6 illustrates that, in some embodiments, a serving gNB 601 sends configuration information of N SRS resources to a UE 602. The serving gNB 601 transmits downlink CSI-RS at an operation 620 to the UE 602 for downlink channel measurement. Based on the result of measurement of downlink CSI-RS from the serving gNB 601, the UE 602 can estimate a precoding granularity value and the UE 602 can estimate one or more candidate precoders based on estimated precoding granularity. Then the UE 602 reports a precoding granularity value to the serving gNB 601 in an operation 640. In one example, the UE 602 can use a PUCCH resource that is triggered by a DCI format to report the precoding granularity value. Examples of that DCI format can be: a DCI format that triggers the transmission on SRS resources, or a DCI format that triggers the transmission of downlink CSI-RS resource.

With the estimated precoding granularity that is reported to the serving gNB 601, the UE 602 transmit SRS in each of those SRS resources. The UE 602 can apply the estimated precoder(s) corresponding to the precoding granularity reported to the serving gNB on the transmission in those SRS resources. Then the serving gNB receives and measures the transmission in those SRS resources. The serving gNB 601 can determine which SRS resource is the best for PUSCH transmission and notify such information to the UE 602 for PUSCH transmission.

In summary, FIG. 6 illustrates that, in some embodiments, the serving gNB 601 configuring the UE 602 for PUSCH transmission includes: at the operation 610, configuration information including N SRS resources can be configured by the serving gNB 601 to the UE 602, at the operation 620, the serving gNB 601 transmits downlink CSI-RS to the UE 602, at the operation 630, the UE 602 can estimate precoding granularity and precoders for SRS transmission, at the operation 640, the UE 602 can report one precoding granularity, at the operation 650, the UE 502 can transmit SRS resources with reported precoding granularity and estimated precoders.

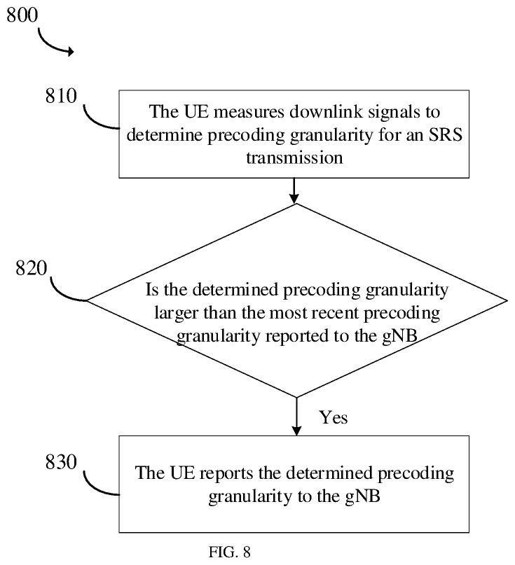

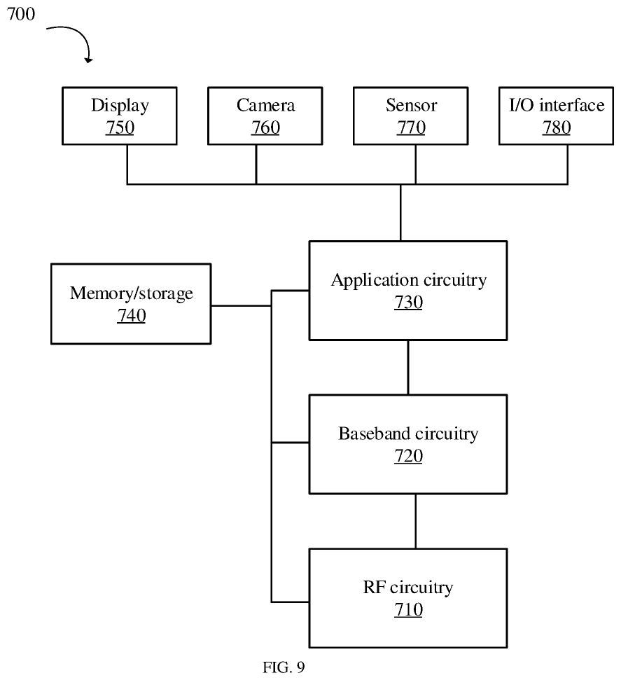

FIG. 7 is a flowchart illustrating a method of frequency-selective precoding for physical uplink shared channel (PUSCH) transmission according to an embodiment of the present disclosure. FIG. 8 is a flowchart illustrating a method of frequency-selective precoding for physical uplink shared channel (PUSCH) transmission according to an embodiment of the present disclosure. FIG. 7 illustrates that, in some embodiments, a method 700 includes: in a block 710, a UE measures downlink signals to determine precoding granularity for an SRS transmission, in a block 720, is the determined precoding granularity different from the most recent precoding granularity reported to a gNB, if yes, and in a block 730, the UE reports the determined precoding granularity to the gNB. FIG. 8 illustrates that, in some embodiments, a method 800 includes: in a block 810, a UE measures downlink signals to determine precoding granularity for an SRS transmission, in a block 820, is the determined precoding granularity larger than the most recent precoding granularity reported to a gNB, if yes, and in a block 830, the UE reports the determined precoding granularity to the gNB.

In one example, the UE can use a higher layer signaling, for example medium access control control element (MAC CE) message, to report a precoding granularity value for an SRS resource. The UE does not need report precoding granularity for every measurement on downlink CSI-RS because it is expected that the precoding granularity would change slowly. The UE can report a precoding granularity when the UE finds the latest precoding granularity is different from the most recent precoding granularity reported to the gNB, as illustrated in FIG. 7. In another example, if the latest determined precoding granularity value is larger than the most recent precoding granularity reported to the gNB, as illustrated in FIG. 8.

In one example, for an SRS resource that is configured with precoding granularity value, if the UE does not report a precoding granularity or if the UE has not reported a precoding granularity for that SRS resource, the UE can assume a default precoding granularity for the transmission on that SRS resource. One example of a default precoding granularity can be wideband. One example of a default precoding granularity can be 1 resource block. One example of a default precoding granularity can be 2 consecutive blocks. One example of a default precoding granularity can be 4 consecutive resource blocks.

In one embodiment, a UE can be configured with N SRS resources. The UE can be requested by the gNB to report a precoding granularity for uplink transmission. The UE can use downlink signals, for example downlink CSI-RS resource transmission to determine a precoding granularity for uplink transmission and then report it to the gNB. After reporting, the UE can assume the UE would apply the reported precoding granularity on the transmission of those N SRS resources and also on the transmission of granted PUSCH. For a transmission in an SRS resource, the UE can determine precoder(s) according to the precoding granularity reported to the gNB and estimated channel state information. As explained previously, the UE can report a precoding granularity for uplink transmission through a PUCCH resource. The UE can report a precoding granularity for uplink transmission through a higher layer signaling, for example a MAC CE message. In one example, if the UE has not reported one precoding granularity value for uplink transmission to the gNB, the UE can assume to use a default precoding granularity for uplink transmission, for example for the SRS resource for PUSCH transmission and PUSCH transmission. As explained in an example in this disclosure, examples of a default precoding granularity can be wideband, 1 resource blocks, 2 consecutive blocks or 4 consecutive resources.

In one embodiment, a UE is configured with a first SRS resource. The first SRS resource can be configured with a precoding granularity and for a transmission on the first SRS resource, the UE can apply a precoding granularity that is equal to or larger than the precoding granularity that is configured to the first SRS resource. The UE can determine one precoding granularity for the first SRS and reports the determined precoding granularity to the gNB. For a transmission on the first SRS resource, the UE can apply a precoding granularity that is equal to or larger than the precoding granularity that the UE reports to the gNB. Similarly, for a PUSCH transmission, the UE can determine a precoding granularity based on the indication from the gNB. For the PUSCH transmission, the UE can apply a precoding granularity that is equal or larger than the precoding granularity that the UE determines based on the indication from the gNB.

In summary, in some embodiments of the present disclosure, the methods of frequency-selective precoding for PUSCH transmission are proposed. One method is the gNB (Next Generation NodeB) configures the UE to transmit SRS resources with subband-based precoding. Another method is that the UE determines the best uplink precoding granularity and corresponding candidate precoders. The UE reports the determined uplink precoding granularity to the gNB and the UE transmits SRS resources with reported uplink precoding granularity and corresponding precoders to the gNB for the gNB to measure the uplink channel. Another method is the gNB configures one or more sets of SRS resources and each set is configured with a uplink precoding granularity value. The UE transmit SRS in each of SRS resource set and the gNB measures those SRS resources to determine one SRS set and one or more SRS resources in that set for uplink transmission. The gNB notifies the index of selected set and indices of SRS resources to the UE for PUSCH transmission.

In the embodiment of the present disclosure, methods and apparatuses of frequency-selective precoding for physical uplink shared channel (PUSCH) transmission capable of providing at least one of advantages including selecting a best precoding granularity and also a best precoder for each subband of one PUSCH transmission, increasing a beamforming gain on the PUSCH transmission, and increasing a coverage and throughput of an uplink transmission in a new radio (NR) system are provided. In other words, according to some embodiments of the present disclosure, the system can select best precoding granularity and also the ‘best’ precoder for each subband (for example one or more resource blocks in frequency domain) of one PUSCH transmission. The beamforming gain on PUSCH transmission is increased in comparison with the wideband precoder method that is supported in current methods. The presented method of some embodiments of the present disclosure can increase the coverage and throughput of uplink transmission in NR system. Some embodiments of the present disclosure are a combination of techniques/processes that can be adopted in 3GPP specification to create an end product.

FIG. 9 is a block diagram of an example system 900 for wireless communication according to an embodiment of the present disclosure. Embodiments described herein may be implemented into the system using any suitably configured hardware and/or software. FIG. 9 illustrates the system 900 including a radio frequency (RF) circuitry 910, a baseband circuitry 920, an application circuitry 930, a memory/storage 940, a display 950, a camera 960, a sensor 970, and an input/output (I/O) interface 980, coupled with each other at least as illustrated.

The application circuitry 930 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 920 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc.

In some embodiments, the baseband circuitry may provide for communication compatible with one or more radio technologies.

For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 920 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 910 may enable communication with wireless networks using modulated electromagnetic radiation through a non-solid medium.

In various embodiments, the RF circuitry may include switches, filters, amplifiers, etc. to facilitate the communication with the wireless network.

In various embodiments, the RF circuitry 910 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality.

In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 940 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 980 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 970 may include one or more sensing devices to determine environmental conditions and/or location information related to the system.

In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 950 may include a display, such as a liquid crystal display and a touch screen display.

In various embodiments, the system 900 may be a mobile computing device such as, but not limited to, a laptop computing device, a tablet computing device, a netbook, an ultrabook, a smartphone, etc.

In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of frequency-selective precoding for physical uplink shared channel (PUSCH) transmission of a user equipment (UE), comprising:
receiving, from a base station (BS), configuration information for a set of sounding reference signal (SRS) resources and a downlink reference signal (RS) for measuring channel state information; and
identifying a precoder for an SRS resource in the set of SRS resources according to a precoding granularity value.

2. The method of claim 1, further comprising receiving, from the BS, a first precoding granularity value for the set of SRS resources and calculating the precoder for the SRS resource in the set of SRS resources according to the first precoding granularity value.

3. The method of claim 1, further comprising determining the precoding granularity value for the SRS resource in the set of SRS resources according to the channel state information.

4. The method of claim 3, further comprising reporting the determined precoding granularity value to the BS.

5. The method of claim 1, further comprising receiving, from the BS, an indication signaling that schedules a PUSCH transmission and carries an indicator that indicates the set of SRS resources and the SRS resource in the set of SRS resources.

6. The method of claim 5, further comprising transmitting the PUSCH transmission with the precoder and the precoding granularity value used by the indicated SRS resource in the indicated set of SRS resources.

7. The method of claim 5, further comprising transmitting the PUSCH transmission with a precoding granularity value which is equal to or greater than the precoding granularity value used by the SRS resource in the set of SRS resources.

8. The method of claim 1, further comprising receiving from, the BS, configuration information of N SRS resources and each precoding granularity value configured to each SRS resource, wherein the precoding granularity value configured to a first SRS resource can be different from the that configured to a second SRS resource.

9. A user equipment (UE) of frequency-selective precoding for physical uplink shared channel (PUSCH) transmission, comprising:
a memory;
a transceiver; and
a processor coupled to the memory and the transceiver;
wherein:
the transceiver is configured to receive, from a base station (B S), configuration information for a set of sounding reference signal (SRS) resources and a downlink reference signal (RS) for measuring channel state information; and
the processor is configured to identify a precoder for an SRS resource in the set of SRS resources according to a precoding granularity value.

10. The UE of claim 9, wherein the transceiver is configured to receive, from the BS, a first precoding granularity value for the set of SRS resources and the processor is configured to calculate the precoder for the SRS resource in the set of SRS resources according to the first precoding granularity value.

11. The UE of claim 9, wherein the processor is configured to determine the precoding granularity value for the SRS resource in the set of SRS resources according to the channel state information.

12. The UE of claim 11, wherein the transceiver is configured to report the determined precoding granularity value to the BS.

13. The UE of claim 9, wherein the transceiver is configured to receive, from the BS, an indication signaling that schedules a PUSCH transmission and wherein the processor is configured to carry an indicator that indicates the set of SRS resources and the SRS resource in the set of SRS resources.

14. The UE of claim 13, wherein the transceiver is configured to transmit the PUSCH transmission with the precoder and the precoding granularity value used by the indicated SRS resource in the indicated set of SRS resources.

15. The UE of claim 13, wherein the transceiver is configured to transmit the PUSCH transmission with a precoding granularity value which is equal to or greater than the precoding granularity value used by the SRS resource in the set of SRS resources.

16. The UE of claim 9, wherein the transceiver is configured to receive from, the BS, configuration information of N SRS resources and each precoding granularity value configured to each SRS resource, wherein the precoding granularity value configured to a first SRS resource can be different from the that configured to a second SRS resource.

17. Abase station (BS) of frequency-selective precoding for physical uplink shared channel (PUSCH) transmission, comprising:
a memory;
a transceiver; and
a processor coupled to the memory and the transceiver;
wherein:
the transceiver is configured to transmit, to a user equipment (UE), configuration information for a set of sounding reference signal (SRS) resources;
the transceiver is configured to transmit, to the UE, configuration information of a precoding granularity value for the set of SRS resources; and
the transceiver is configured to transmit, to the UE, a downlink reference signal (RS) for measuring channel state information.

18. The BS of claim 17, wherein the transceiver is configured to receive, from the UE, a precoding granularity report for an SRS resource in the set of SRS resources.

19. The BS of claim 17, wherein the transceiver is configured to receive an SRS transmission in the set of SRS resources and wherein the processor is configured to select an SRS resource in the set of SRS resources.

20. The BS of claim 17, wherein the transceiver is configured to transmit, to the UE, a signaling command that schedules a PUSCH transmission and coveys an indicator that indicates the set of SRS resources and an SRS resource in the set of SRS resources.
